(19) United States
(12) Patent Application Publication
(10) Pub. No.: US 2006/0233553 A1
(43) Pub. Date: Oct. 19, 2006

(54) Optical transceiver module having adjustable signal polarity

(76) Inventor: Stephen T. Nelson, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/386,589

(22) Filed: Mar. 22, 2006

Related U.S. Application Data
(60) Provisional application No. 60/664,014, filed on Mar. 22, 2005.

(51) Int. Cl. H04B 10/00

(52) U.S. Cl. 398/135

(57) ABSTRACT

A system and method for selective inversion of the polarity of differential electrical data signals in connection with the operation of an optical transceiver module is disclosed. In one embodiment, an optical transceiver module is disclosed and comprises a receiver optical subassembly in operable communication with dual receive data signal streams that possess respectively differing polarities. A transmitter optical subassembly is also disclosed in operable communication with dual transmit data signal streams that possess respectively differing polarities. A first polarity switch is included and configured to selectively invert the polarities of the data signal streams of the receive data path, while a second polarity switch is included and configured to selectively invert the polarities of the data signal streams of the transmit data path. A register array is included in the module and has bits assignable by a controller that selectively enable operation of the polarity switches.

### CROSS-REFERENCE TO RELATED APPLICATIONS

This application claims the benefit of U.S. Patent Application No. 60/664,014, entitled “Optical Transceiver Module Having Adjustable Signal Polarity,” filed on Mar. 22, 2005, which is incorporated herein by reference in its entirety.

### BACKGROUND

1. Technology Field

The present invention generally relates to optical transceiver modules. In particular, the present invention relates to an optical transceiver module that can selectively adjust the polarity of data signals both transmitted and received by the module.

2. The Related Technology

Specified Multi-Source Agreements (“MSAs”) govern various aspects of data-containing optical signals that are both transmitted and received by optical transceiver modules (“transceivers”), which are typically employed in high-speed communications networks. One optical signal aspect defined by certain MSAs is the polarity of the optical signal that is transmitted or received by components of the transceiver. The “polarity” of the optical signal does not refer to a positive or negative charge, but rather a scale by which the value of digital data transmitted via the optical signal is ascertained. For example, if a logical “1” is transmitted where a logical “0” should have been transmitted, such data may be referred to as inversely or improperly polarized.

In general, data carried to, from, or within the transceiver are often transmitted via dual data paths. The dual data paths operate as differential data paths, wherein one data path operates as the inverse of the other. For example, a logical “1” to be carried will be represented on a first of the dual data paths as a relatively high value, while on the second data path it is represented as a relatively low value. Correspondingly, a logical “0” would be inversely represented as a relatively low value on the first data path and a relatively high value on the second data path. This enables digital interpretation of a logical “1” or “0” in the context of differential data paths by defining a particular relationship between the two data paths as signifying either a “1” or a “0” and then interpreting the received signal accordingly.

In any event, once a particular convention is selected, it is important that the relationship between the data paths be maintained so that the appropriate significance can be assigned to the detected differential between the two paths. However, problems sometimes occur that may compromise this relationship, and thus the error rate, among other things, of the transmitted data.

For example, as the data, in the form of a predetermined relationship such as those described above, is received, processed and/or transmitted by various system components, the data may become inverted so that a transmitted “1” becomes a “0” at some point in the system. As suggested above, such inversion may take the form, for example, of a reversed electrical polarity between the data paths. Data inversion may result, for example, from operations performed by of one or more of the system components, and/or from effects imposed by various conditions occurring within the operating environment of the system.

Often this polarity inversion is caused by unintended or intended crossover of the dual data paths at or within the host system with which the transceiver is attached and to/from which the transceiver forwards and receives data. In yet other cases, data inversion may result from the physical arrangement of the system circuitry. By way of example, if the data paths are somehow reversed during construction of the PCB, and such reversal is not identified and compensated for in some manner, data inversion will likely result. In any case, such data inversion is problematic. For example, the inversion of all the “1”s in a data stream to “0”s would result in a one hundred percent error rate, an undesirable result.

In light of the above, a need exists in the art for a transceiver having functionality that can compensate for the challenges described above. In particular, an optical transceiver is needed that can compensate for data signal polarity inversion in order to preserve the integrity of the data transmitted therewith. Moreover, any solution to the above should be implemented within the transceiver or other optical component as a transparent solution vis-á-vis the host system so as to simplify the solution for the customer. In addition, any solution that can permit selective signal polarity adjustment via either external host interaction or intra-device control would also be beneficial.

### BRIEF SUMMARY

The present invention has been developed in response to the above and other needs in the art. Briefly summarized, embodiments of the present invention are directed to a system and method for selective inversion of the polarity of differential electrical data signals in connection with the operation of an optical transceiver module.

In one embodiment, an optical transceiver module is disclosed and comprises a receiver optical subassembly in operable communication with dual receive data signal streams that possess respectively differing polarities. A transmitter optical subassembly is also disclosed in operable communication with dual transmit data signal streams that possess respectively differing polarities. A first polarity switch is included and configured to selectively invert the polarities of the data signal streams of the receive data path, while a second polarity switch is included and configured to selectively invert the polarities of the data signal streams of the transmit data path. A register array is included in the module and has bits assignable by a controller that selectively enable operation of the polarity switches.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an optical transceiver module that is configured in accordance with embodiments of the present invention;

FIG. 2A is a simplified block view of an optical transceiver module including one embodiment of a system for selectively inverting data signal polarity

FIG. 2B shows the optical transceiver module of FIG. 2A in a first polarity inversion state according to one embodiment;

FIG. 2C shows the optical transceiver module of FIG. 2A in a second polarity inversion state according to one embodiment;

FIG. 3 is a simplified block view of an optical transceiver module including another embodiment of a system for selectively inverting data signal polarity; and

FIG. 4 is a simplified block diagram showing one exemplary operating environment where an embodiment of the present invention can be employed.

### DETAILED DESCRIPTION

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

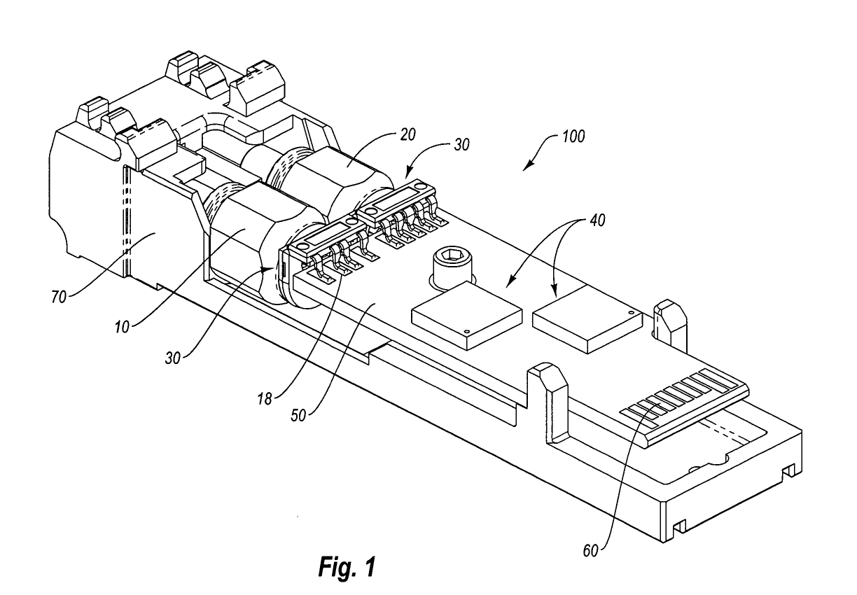

FIGS. 1-4 depict various features of embodiments of the present invention, which is generally directed to systems and methods for determining and selecting the polarity of data signals transmitted via differential signal paths of an optical transmitter and/or optical receiver. Practice of embodiments of the invention enables polarity corrections to be made within the optical transmitter, receiver, or other optical component, such as when data signal polarity inversion occurs between the component and a host, or when design limitations prevent a desired signal line layout.

1. Exemplary Operating Environment

Reference is first made to FIG. 1, which depicts a perspective view of an optical transceiver module (“transceiver”), generally designated at 100, for use in transmitting and receiving optical signals in connection with an external host that is operatively connected in one embodiment to a communications network. As shown, the transceiver shown in FIG. 7 includes various components, including a receiver optical subassembly (“ROSA”) 10, a transmitter optical subassembly (“TOSA”) 20, electrical interfaces 30, various electronic components 40, and a printed circuit board 50. In detail, two electrical interfaces 30 are included in the transceiver 100, one each used to electrically connect the ROSA 10 and the TOSA 20 to a plurality of conductive pads located on the PCB 50. The electronic components 40 are also attached to the PCB 50. An edge connector 60 is located on an end of the PCB 50 to enable the transceiver 100 to electrically interface with a host (not shown here). As such, the PCB 50 facilitates electrical communication between the ROSA 10/TOSA 20 and the host. In addition, the above-mentioned components of the transceiver 100 are partially housed within a shell, or housing 70. Though not shown, a cover can cooperate with the housing 70 to define a substantial covering for the components of the transceiver 100.

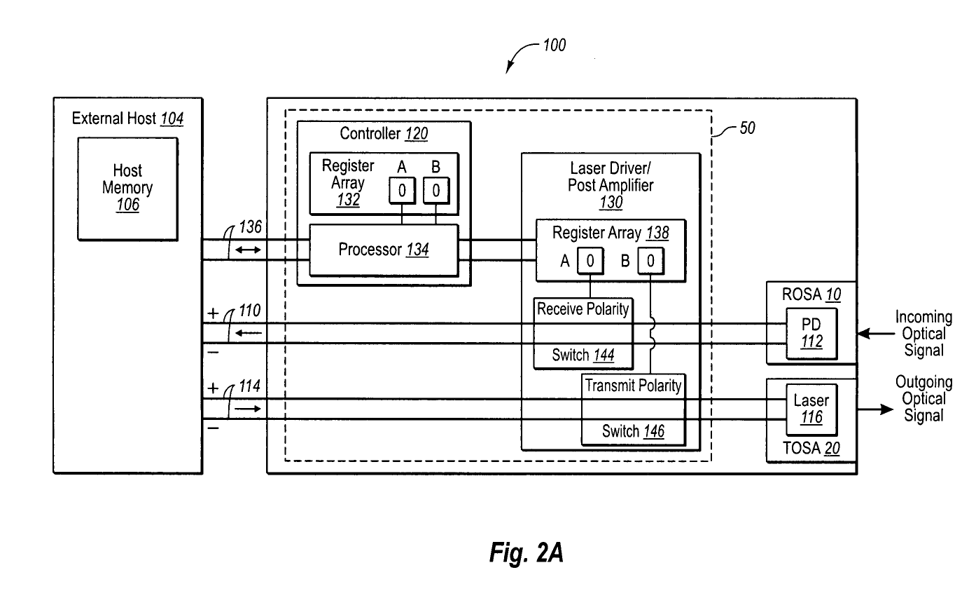

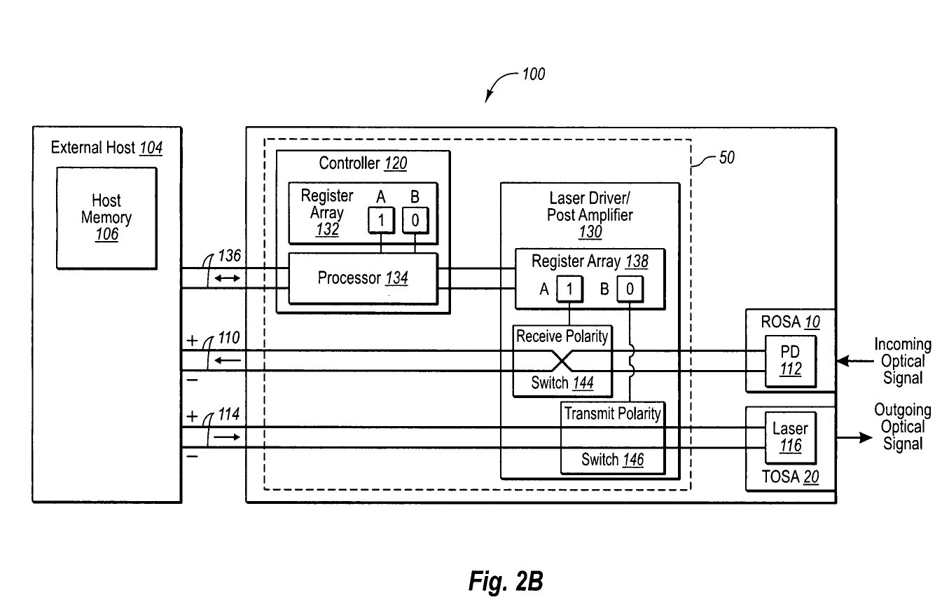

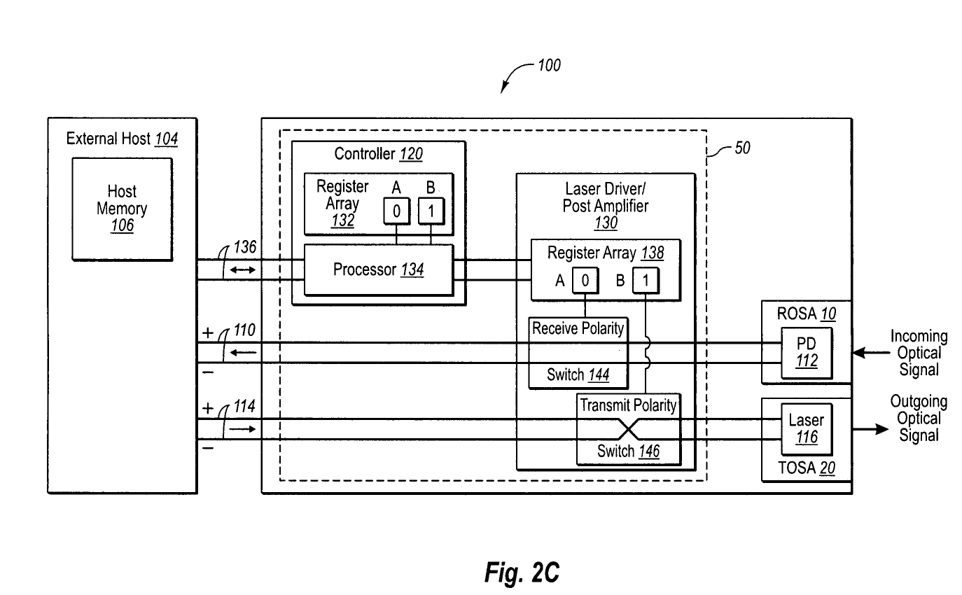

Reference is now made to FIG. 2A, which is a simplified block diagram of the transceiver 100 of FIG. 1, depicting various physical and operational aspects thereof, including various details of the present invention, according to one embodiment. As mentioned, embodiments of the present invention are directed to a system by which the polarity of electrical data signals associated with an optical transmitter and/or optical receiver can be selectively inverted according to need or desire. Note that, while the optical transceiver 100 in which embodiments of the present invention can be practiced will be described in some detail, it is described by way of illustration only, and not by way of restricting the scope of the invention. Indeed, other electrical data signal-carrying devices and components can similarly benefit from embodiments of the present invention.

As mentioned above, the optical transceiver 100 in one embodiment is suitable for optical signal transmission and reception at a variety of per-second data rates, including but not limited to 1 Gbit, 2 Gbit, 4 Gbit, 8 Gbit, 10 Gbit, or higher bandwidth fiber optic links. Furthermore, the principles of the present invention can be implemented in optical transceivers of any form factor such as XFP, SFP and SFF, without restriction.

In detail, FIG. 2A shows a simplified block diagram of various components of the transceiver 100 of FIG. 1. During operation, the transceiver 100 can receive a data-containing electrical signal from an external host 104, which host can be any computing system capable of communicating with the optical transceiver 100, for transmission as a data-carrying optical signal on to an optical fiber (not shown). The host 104 can further include a host memory 106 that can be a volatile or non-volatile memory source. The electrical data signal supplied to the transceiver 100 from the host 104 is carried via a pair of differential transmit signal lines 114, shown in FIG. 2A. Each signal line of the differential signal line pair carries one of two streams of the data signal that differ from each other only in signal polarity. As such, the lines are respectively indicated with a “+” or a “−” indicator, indicating the respective positive or negative polarity of each line. This opposing polarity of the differential electrical data signal streams facilitates more accurate deciphering of the data contained therein by expanding the differential magnitude between a logical “1” bit and a logical “0” bit. As such, the differential electrical data signals represent a single stream of digital data that travel in the same propagation direction.

The electrical differential data signal is provided to a light source, such as a laser 116 located in the TOSA 20, which converts the electrical signal into a data-carrying optical signal for emission on to an optical fiber and transmission via an optical communications network, for instance. The laser 116 can be an edge-emitting laser diode, a vertical cavity surface emitting laser (“VCSEL”), a distributed feedback (“DFB”) laser, or other suitable light source. Accordingly, the TOSA 20 serves as an electro-optic transducer.

In addition, the transceiver 100 is configured to receive a data-carrying optical signal from an optical fiber via the ROSA 10. The ROSA 10 acts as an opto-electric transducer by transforming the received optical signal, via a photodetector 112 or other suitable device, into an electrical data signal. The resulting electrical data signal is carried via a pair of differential receive signal lines 110. As is the case with the differential transmit signal lines 114, each signal line of the differential receive signal lines 110 carries one of two streams of the differential electrical data signal that differ from each other only in signal polarity. As such, the lines are respectively indicated with a “+” or a “−” indicator, indicating the respective positive or negative polarity of each line.

Various electronic components are included on the PCB 50 of the transceiver 100 to assist in data signal transmission and reception. In the illustrated embodiment, a post amplifier for amplifying the electrical signal received from the photodetector 112 is consolidated with a laser driver for driving the laser 116 to form an integrated laser driver/post amplifier (“LDPA”) 130. As such, the LDPA 130 resides on a single integrated circuit chip and is included as a component, together with the other electronic components, some of which are further described below, on the PCB 50. In one embodiment, the LDPA and controller can be integrated together on a single IC chip. Further details regarding such an integrated controller and LDPA can be found in U.S. patent application Ser. No. 10/970,529, entitled “Integrated Post Amplifier, Laser Driver, and Controller,” filed Oct. 21, 2004 (the “'529 application”), which is incorporated herein by reference in its entirety. In other embodiments, the post amplifier and laser driver can be included as separate components on the PCB 50.

The behavior of the ROSA 10, the LDPA 130, and the TOSA 20 may vary dynamically due to a number of factors. For example, temperature changes, power fluctuations, and feedback conditions may each affect the performance of these components. Accordingly, the transceiver 100 further includes a controller 120, which can evaluate conditions pertinent to transceiver operation, such as temperature or voltage, and receive information from the post-amplifier and laser driver portions of the LDPA 130. This in turn allows the controller 120 to optimize the dynamically varying performance of the transceiver 100. In one embodiment, the controller 120 can include both an analog portion and a digital portion that together allow the controller to implement logic digitally, while still largely interfacing with the rest of the optical transceiver 100 using analog signals. Also, though the controller 120 and LDPA 130 may be included on the same chip (as disclosed in the '529 application), in the present embodiment the controller is included on the PCB 50 as a component separate from the LDPA.

2. Selection and Adjustment of Signal Polarity

In accordance with one embodiment of the present invention, the transceiver 100 is configured to provide electrical data signal polarity inversion. As such, in one embodiment the transceiver 100 includes various components designed to enable such polarity inversion to occur. In particular, and as shown in FIG. 2A, the controller 120 includes a register array 132 and a processor 134. The controller 120 is in operable communication with the host 104 via a communication bus, such as pair of digital signal lines 136, such that instructions and other data can flow between the host and the processor 134 and/or register array 132. Note that the digital signal lines 136 can take a variety of forms, such as an I2C interface or dedicated I/O pins interconnecting the host and controller via the edge connector 60 (FIG. 1) of the module 100.

In addition, the LDPA 130 includes a register array 138, a receive polarity switch 144 and a transmit polarity switch 146. In the present embodiment, the register array 138 of the LDPA 130 is in digital communication with the processor 134 to enable specified communication between the controller 120 and the LDPA to occur. In another embodiment, the controller 120 and the LDPA 130 are in analog communication with one another. These components are described below in greater detail in connection with their use in inverting data signals.

In the illustrated embodiment, the controller 120 governs electrical data signal polarity inversion operations within the transceiver 100, according to directions received from the host 104. In one embodiment, this governance is implemented by the components described above. In greater detail, the register array 132 of the controller 120, which is composed of volatile or non-volatile memory, includes two assignable memory locations” an “A-bit” and a “B-bit, as seen in FIG. 2A. The A-bit and B-bit of the register array 132 are assignable by the processor 134. The processor 134 can assign the A-bit and B-bit autonomously in accordance with its execution of microcode, or as directed by the host 104 via the digital signal lines 136. In the present embodiment, the A-bit and the B-bit of the register array 132 can be toggled between a “0” and “1” logic bit value, wherein the logic “0” indicates normal operation mode, while a logic “1” indicates a polarity inversion mode, as will be explained further below.

It is appreciated that in one embodiment the A-bit and B-bit of the controller register array can be assigned directly by the external host. In this case, the processor continually monitors the register array to determine when data signal polarity inversion activities should be commenced. In yet another embodiment, the A-bit and B-bit of the register array of the LDPA can be directly assignable by the external host, thereby bypassing use of the module controller in assigning bit values. In this latter case, the module can be configured such that H the host has access to the assignable bits in the LDPA via select I/O pins.

Similar to the controller 120, the LDPA 130 also includes a volatile or non-volatile register array, i.e., the register array 138. The register array 138 includes two assignable memory locations: an “A-bit” and a “B-bit,” which can each be toggled between logic “0” and “1” values. The assignment of values to these bits is governed by the processor 134, made possible by its digital connection with the register array 138. Again, in another embodiment, the controller and LDPA could be interconnected by an analog connection. The A-bit and B-bit of the register array 138 are in turn operably connected to a receive polarity switch 144 and a transmit polarity switch 146, respectively, of the LDPA 130. The logic value assigned to each of the A-bit and the B-bit respectively determines the functionality of the polarity switches 144 and 146 in selectively inverting the polarity of the electrical data signals carried by the differential signal lines 110 and 114, respectively, as explained further below.

In greater detail, the receive and transmit polarity switches 144 and 146 are configured to switch electrical data signal streams from each signal line of the respective differential signal line pair operably connected thereto to the other signal line. In the present embodiment the polarity switches 144 and 146 are analog switches that are controlled via an analog signal sent by the LDPA 130. Alternatively, digital switches could be used. Note that one of several types of devices to invert data signal polarity could be employed as the polarity switches 144, 146.

Together with FIG. 2A, reference is now made to FIGS. 2B and 2C. As already has been mentioned, the transceiver 100 can operate in at least two modes: a normal operation mode where the transceiver operates in usual fashion without signal polarity inversion to transmit and receive optical data signals, and a signal polarity inversion mode where the transceiver inverts at least one of the receive and transmit electrical data signals carried via the transceiver.

As seen in FIG. 2A, in normal mode operation the transceiver 100 transmits an electrical data signal from the host 104 via the differential transmit signal lines 114, through the LDPA 130, to the laser 116 of the TOSA 20 for conversion to an optical data signal and emission onto an optical fiber (not shown). Simultaneously, the transceiver 100 can receive an optical data signal from an optical fiber (not shown) operably connected to the photodetector 112 of the ROSA 10. The optical data signal is converted to an electrical data signal by the photodetector before being forwarded, through the LDPA 130, to the host via the differential receive signal lines 110. In this normal operation mode, the A-bit and B-bit of the register array 132 and the A-and B-bits of the register array 138 are set to logical “0,” indicating that the polarity inversion procedures and components are dormant for both the receive and transmit data paths. Note that the value of the A-and B-bits of both the register array 132 and the register array 138 mimic one another, as the bit values of the array 138 are dictated by those of the array 132 as communicated from the controller 120 to the LDPA 130. Note that the particular logical value assigned to the corresponding bits is not important; as such, other values could be used to indicate normal/polarity inversion modes.

In response to a command issued by the host to either the processor 134, register array 132, or other component of the controller 120, a logical “1” value is assigned to either the A-bit or B-bit of the register array 132, depending on which data path is to be inverted in polarity. This causes the transceiver 100 to switch into polarity inversion mode, as seen in FIG. 2B. Assuming it is the receive data signal streams that are to be polarity inverted, the A-bit of the register array 132 is changed to a “1” value to indicate the receive data path polarity inversion mode. The processor 134 communicates with the register array 138 of the LDPA 130 and assigns a logical “1” value to its A-bit, thereby activating the polarity inversion mode in the LDPA 130, which in turn causes the LDPA to toggle, or activate, the receive polarity switch 144.

In further detail, FIG. 2B shows the receive polarity switch 144 activated as a result of the A-bit being set to a logical “1” by the processor 134, and the B-bit remaining at logical “0.” This corresponds to the bit assignments of the register array 132. In this configuration, activation of the receive polarity switch 144 causes the electrical data signal stream—being carried from the ROSA 10 to the host 104 on the positive (+) differential receive signal line 110—to be switched at the switch 144 to the negative (−) differential receive signal line.

Similarly and simultaneously, the electrical data signal stream of the negative (−) differential receive signal line is switched to the positive (+) differential receive signal line. This operation by the receive polarity switch 144 results in a polarity inversion of the differential electrical data signal carried by the differential receive signal lines 110. The data signal exits the module 100 with this assigned inverted polarity and is then forwarded to the host 104 or other suitable destination.

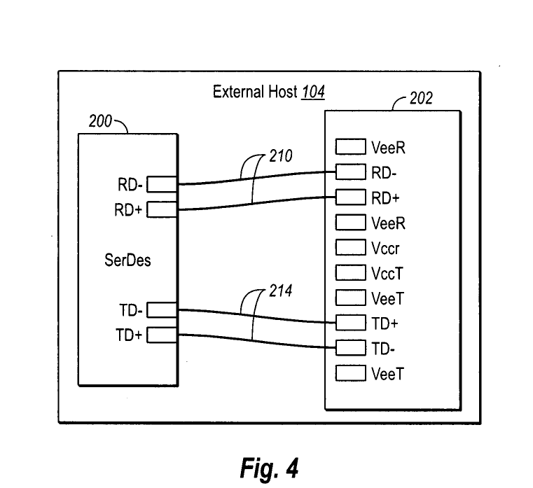

Such polarity inversion of the data signal can correct, for example, an undesired signal polarity promulgated by components upline from the transceiver 100, or to align the data signal polarity with that to which the host 104 is configured. As an illustration of this latter case, reference is made to FIG. 4, which shows selected internal components of the external host 104 (shown also in FIG. 2A), including a serial/deserializer (“SERDES”) 200 having conductive pads RD+, RD− for receiving differential electrical receive data signals and pads TD+, TD− for transmitting differential electrical transmit data signals. A host connector portion 202 is also shown, having a plurality of conductive pads configured to electrically connect with corresponding pads located on the edge connector 60 of the module 100 (FIG. 1) when the module is received into the host 104. Selected conductive pads of the SERDES 200 are also interconnected with certain pads of the host connector portion 202 to enable transmission and receipt of data signals to and from the host 104. Specifically, the conductive pads of the host connector portion 202 include two pads, RD+ and RD− for transferring differential electrical receive data signals to the corresponding RD+ and RD− pads on the SERDES 200 via data signal lines 210, and two pads, TD+ and TD−, for receiving differential electrical transmit data signals from the corresponding TD− and TD+ pads on the SERDES via data signal lines 214.

Inspection of FIG. 4 reveals that the arrangement of the TD− and TD+ pads of the SERDES 200 is reverse the TD+ and TD− pad arrangement of the host connector portion 202. Thus, an undesired polarity switch occurs as a result of connection of the data signal lines 214 as shown in FIG. 4. Further, simple switching or crossing of the data signal lines 214 from that shown in FIG. 4 may not be possible due to internal host design considerations. Hence, embodiments of the present invention can provide for correction of this unintended inversion by employing the polarity inversion capability described herein.

FIG. 2C shows a corresponding configuration to the above, wherein activation of the polarity inversion mode, indicated by the setting of the controller register array A-bit to logic “0” and the B-bit to logic “1”causes a similar bit assignment in the LDPA register array 138: A-bit to logic “0,” and B-bit to “1.” This in turn activates the transmit polarity switch 146, which intercepts the differential data signal streams traveling from the host 104 to the TOSA 20 and switches the electrical data signal streams from either the positive (+) differential transmit signal line 114 or the negative (−) differential transmit signal line to the other corresponding line, as shown in FIG. 2C. Again, this results in a polarity inversion of the electrical data signal carried by these differential lines 114 at the transmit polarity switch 146, thereby inverting the electrical data streams to the TOSA 20 from what would otherwise be received.

As will be shown below, it is possible in one embodiment for both the transmit and receive data streams to be inverted in polarity, if desired or needed. This would be indicated by both the A- and B-bits of the register array 132 and register array 138 being set a logic “1” value. Generally note further that the processor or LDPA of the transceiver can be configured to select which of the above data signal polarity inversion schemes, i.e., polarity inversion of the receive data signal only, the transmit data signal only, or both, will be executed.

When polarity inversion of the particular data signal is no longer needed or desired the processor 134, by instruction from the host 104, changes the A-bit and/or B-bit of the register array 132 to logical “0,” indicating a return to normal transceiver mode. The processor 134 can then re-assign each of the A- and B-bits of the register array 138 of the LDPA 130 to logical “0,” causing the respective receive and/or transmit polarity switch 144, 146 to return the data streams to non-inverted polarity configurations.

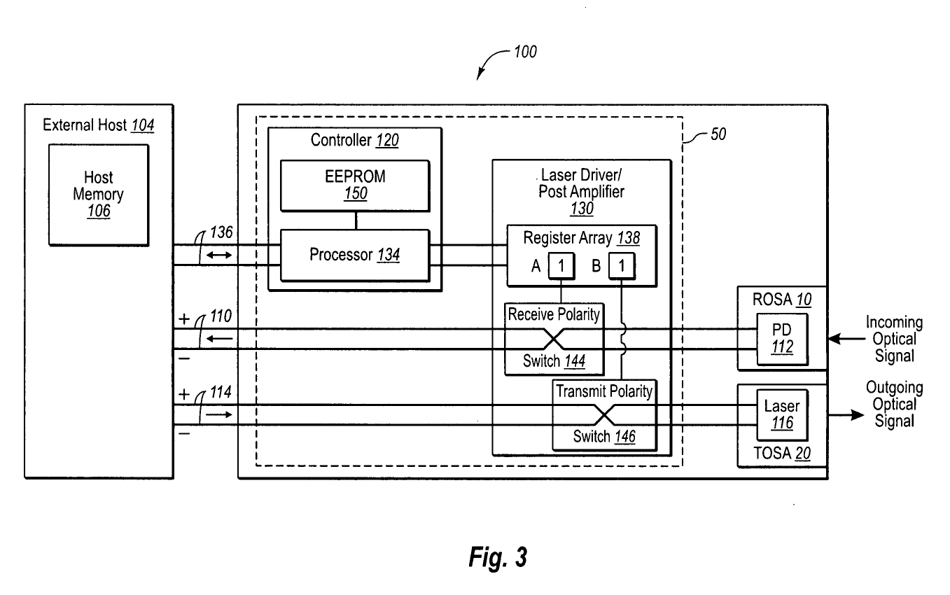

Reference is now made to FIG. 3. In one embodiment, the module 100 can be configured such that instructions concerning whether to invert the polarity of electrical data signals passing through the module are not received external to the module, such as from the external host, but rather are determined within the module itself. FIG. 3 gives one example of such an implementation, wherein a persistent memory location, such as an EEPROM 150, is included in the module and contains instructions for polarity inversion. In the illustrated embodiment, the EEPROM 150 or other suitable memory location is included in the controller 120 and is in operable communication with the processor 134 such that whenever the module is booted up at the commencement of operation, instructions stored in the EEPROM are read by the processor.

These instructions of the EEPROM 150 will enable the processor 134 to set the A- and B-bits of the register array 138 of the LSPA 130, thereby selectively causing polarity inversion, by the polarity switches 144 and/or 146, of the differential electrical data signals passing via the differential receive signal lines 110 or differential transmit signal lines 114, respectively. As illustrated in FIG. 3, both the A-bit and the B-bit have been set to logic “1” by the processor 134, according to instructions contained in the EEPROM 150. As such, data signal polarity inversion occurs at both the receive polarity switch 144 and transmit polarity switch 146. This configuration allows the module 100 to be configured for operation within an environment where some data signal polarity inversion is necessary in order to harmonize the electrical data signals processed by the module with configurations of the external host 104 or some other network component. The configuration shown in FIG. 3 can also be useful in some internal module testing scenarios.

In yet another embodiment, it is appreciated that the need for data signal polarity inversion can be governed automatically by the module itself In particular, the module could be configured to autonomously detect the polarity of an electrical data signal passing therethrough and correct the polarity by inversion, if needed. Such autonomous detection is particularly relevant for communications modules that include the ability to decode data traffic. Thus, this and other uses are therefore appreciated as falling within principles of the present invention.

It should be appreciated that the method disclosed herein in accordance with the discussed embodiments can also be practiced with other transceivers that differ in design and operation from that explicitly shown and described herein.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A communications module configured for selective polarity inversion of a differential electrical data signal, the communications module comprising:
dual data signal lines that each carry one of two differential electrical data signal streams;
an electro-optic transducer in operable communication with the dual data signal lines, the electro-optic transducer configured to convert data between optical and electrical formats;
a polarity switch in operable communication with the dual data signal lines, the polarity switch configured to selectively invert the differential electrical data signal streams between the dual data signal lines; and
a register array having an assignable bit that enables operation of the polarity switch.

2. The communications module as defined in claim 1, wherein a processor of a controller assigns the value to the assignable bit of the register array.

3. The communications module as defined in claim 1, wherein a host that is operably connected to the communications module assigns the value to the assignable bit of the register array.

4. The communications module as defined in claim 3, wherein the register array is included in a consolidated laser driver/post amplifier, and wherein the host is operably connected to the register array via the laser driver/post amplifier.

5. The communications module as defined in claim 1, wherein the communications module is configured to autonomously detect the polarity configuration of the differential electrical data signal streams.

6. The communications module as defined in claim 1, further comprising:
a first polarity switch for inverting differential electrical data signal streams of dual data receive signal lines;
a second polarity switch for inverting differential electrical data signal streams of dual data transmit signal lines; and
a register array having first and second assignable bits that respectively enable operation of the first and second polarity switches.

7. A method for inverting the polarity of dual data signal streams carried by a differential data path in an optical transceiver module, the method comprising:
by a processor of a controller, setting a bit in a register array of a laser driver/post amplifier to activate a polarity switch in operable communication with the differential data path; and
by the polarity switch, inverting the polarity of each of the dual data streams carried by the differential data path.

8. The method for inverting as defined in claim 7, further comprising:
setting a bit in a register array of the controller to indicate activation of a polarity inversion mode.

9. The method for inverting as defined in claim 8, wherein setting the bit in the register array of the controller is performed by an external host.

10. The method for inverting as defined in claim 9, wherein the external host is operably connected to the controller via a digital communication bus.

11. The method for inverting as defined in claim 7, wherein the setting the bit in the register array of the laser driver/post amplifier is performed autonomously by the optical transceiver module.

12. The method for inverting as defined in claim 7, wherein setting the bit in the register array of the laser driver/post amplifier further comprises:
by the processor of the controller in operable communication with a non-volatile memory source, setting a bit in the register array of the laser driver/post amplifier to activate the polarity switch in operable communication with the differential data path.

13. An optical transceiver module, comprising:
a receiver optical subassembly in operable communication with a differential receive data path, the receive data path capable of carrying dual receive data signal streams having respectively differing polarities;
a transmitter optical subassembly in operable communication with a differential transmit data path, the transmit data path capable of carrying dual transmit data signal streams having respectively differing polarities;
a first polarity switch in operable communication with the receive data path or the transmit data path, the first polarity switch configured to selectively invert the polarities of the data signal streams of the respective data path;
a first register array having a first assignable bit that enables operation of the first polarity switch; and
a controller that assigns a value to the first assignable bit.

14. The optical transceiver module as defined in claim 13, further comprising a second polarity switch, wherein the first polarity switch is configured to selectively invert the polarities of the receive data signal streams, and wherein the second polarity switch is configured to selectively invert the polarities of the transmit data signal streams.

15. The optical transceiver module as defined in claim 14, wherein the first register array includes a second assignable bit that enables operation of the second polarity switch, and wherein the controller assigns a value to the second assignable bit.

16. The optical transceiver module as defined in claim 15, wherein the first register array is included in a consolidated laser driver/post amplifier.

17. The optical transceiver module as defined in claim 16, wherein the controller further includes:
a processor that assigns logical values to the first and second assignable bits included in the first register array; and
a second register array that includes first and second assignable bits that are assigned values by an external host, the values of the assignable bits of the second register array determining the assignment f the assignable bits of the first register array by the processor.

18. The optical transceiver module as defined in claim 17, wherein the controller and the consolidated laser driver/post amplifier are included on a single integrated circuit chip.

19. The optical transceiver module as defined in claim 18, wherein the first and second polarity switches are analog switches.
